(19) United States
(12) Patent Application Publication
(10) Pub. No.: US 2012/0058795 A1
(43) Pub. Date: Mar. 8, 2012

(54) METHOD AND SYSTEM FOR PROVIDING EMERGENCY SERVICE

(75) Inventor: Sang Hyun LEE, Seoul (KR)

(73) Assignee: SAMSUNG ELECTRONICS CO. LTD., Suwon-si (KR)

(21) Appl. No.: 13/225,685

(22) Filed: Sep. 6, 2011

(30) Foreign Application Priority Data
Sep. 6, 2010 (KR) 10-2010-0086993

(51) Int. Cl. H04W 4/22

(52) U.S. Cl. 455/521

(57) ABSTRACT

A method and system for providing an emergency service are provided. The method includes broadcasting a channel message by a first mobile terminal in a no service state in response to a request for an emergency service, transmitting a corresponding response message to the first mobile terminal when a second mobile terminal receives the channel message from the first mobile terminal, forming a channel between the first mobile terminal and the second mobile terminal, and performing a communication according to the emergency service between the first mobile terminal and the second mobile terminal by using the formed channel.

### PRIORITY

This application claims the benefit under 35 U.S.C. §119(a) of a Korean patent application filed on Sep. 6, 2010 in the Korean Intellectual Property Office and assigned Serial No. 10-2010-0086993, the entire disclosure of which is hereby incorporated by reference.

### BACKGROUND OF THE INVENTION

1. Field of the Invention

The present invention relates to a method and system for providing an emergency service. More particularly, the present invention relates to a method and system for providing an emergency service for a mobile terminal that is in a no service state.

2. Description of the Related Art

Recently, based on the development of information and communication technology as well as semiconductor technology, improved mobile terminals are being developed and widely used. More particularly, recently developed mobile terminals accomplish a mobile convergence stage which combines functions typically performed by terminals beyond the mobile terminal's traditional area. Typically, in case of the mobile telecommunication terminal, in addition to a general telecommunication function such as a voice communication and a short message service, various multimedia functions such as a TV function (e.g., a mobile broadcasting like a Digital Multimedia Broadcasting (DMB) and a Digital Video Broadcasting (DVB)), a music play function (e.g., MPEG Audio Layer-3 (MP3)), a photographing function, an interne access function, and a dictionary search function are added. In the meantime, when encountering an emergency situation such as a traffic accident or distress during a hike, the user of the mobile terminal has to make a call by using the mobile terminal so as to inform of the emergency situation to a friend, the police, emergency services, and the like. However, in such an emergency situation, the phone call takes a long time and may cause a delay when informing of the emergency situation to the friend, the police station, the emergency services, and the like. In addition, a given condition for the call may not be satisfied. To address these issues, a mobile terminal function of informing of the emergency situation of user is provided. In the emergency situation alert function (e.g., an emergency service), the mobile terminal user can perform a function of informing others of the emergency situation by transmitting an emergency message (e.g., SOS message) to a pre-registered receiver. The mobile terminal receiving the emergency message connects the call to a number sent with the message informing of the emergency situation, so that it is able to handle the emergency situation. However, in such an emergency service, a corresponding mobile terminal requiring the emergency service must always be able to communicate with a corresponding network. That is, the emergency service requires that the mobile terminal is connected to a network. Therefore, if the mobile terminal is in a no-service state, i.e., an environment where a network service is not supported such as entering a shadow area or a natural disaster, there exists no way to inform of the emergency situation according to the emergency service. That is, the existing mobile terminal has a limited environment for informing of the emergency situation, and, accordingly, has a problem in that notifying of the emergency situation of the user is difficult. For example, when the mobile terminal is in a no-service state during an emergency situation like distress during a hike, the emergency service is not available as the network service is not supported. Further, in such an emergency situation, it might be better and faster to request help from a neighboring person. However, the means for informing the neighbor of the emergency situation may be too restrictive in that only the voice of user is used. Hence, there is no way for informing of the emergency situation of the user even when a fast measure is possible by informing a neighbor of the emergency situation of user.

### SUMMARY OF THE INVENTION

Aspects of the present invention are to address at least the above-mentioned problems and/or disadvantages and to provide at least the advantages described below. Accordingly, an aspect of the present invention is to provide a supplementary feature of a mobile terminal which enables a user to handle an emergency situation.

Another aspect of the present invention is to provide a control method and a mobile terminal which can support an emergency service in an area where a network service is not available (i.e., a no service area).

Another aspect of the present invention is to provide an implementation of an optimum emergency service environment which can provide an emergency service of a mobile terminal by directly connecting with a neighboring mobile terminal without the intervention of a network when an urgent situation is generated in a no service area.

Another aspect of the present invention is to provide an implementation of an environment which can support the emergency service even when a mobile terminal is in a no service area, thereby enhancing the convenience and the safety of user by using the mobile terminal.

In accordance with an aspect of the present invention, a method of providing an emergency service is provided. The method includes broadcasting a channel message by a first mobile terminal in a no service state in response to a request for an emergency service, transmitting a corresponding response message to the first mobile terminal when a second mobile terminal receives the channel message from the first mobile terminal, forming a channel between the first mobile terminal and the second mobile terminal, and performing a communication according to the emergency service between the first mobile terminal and the second mobile terminal by using the formed channel.

In accordance with another aspect of the present invention, a recording medium which is readable by computer is provided. The medium includes steps for executing the operating method for emergency service of the present invention in a processor.

In accordance with another aspect of the present invention, a system for providing an emergency service is provided. The system includes a first mobile terminal for generating and broadcasting a channel message for an emergency service in no service state, and for performing communication according to the emergency service after setting a channel with a corresponding mobile terminal when receiving a response message corresponding to the channel message, and a second mobile terminal for, when receiving the channel message that the first mobile terminal broadcasts, unicasting a corresponding response message to the first mobile terminal, and performing communication according to the emergency service through a channel set with the first mobile terminal.

As described above, according to an exemplary method and system for providing an emergency service of the present invention, a method and mobile terminal which can support an emergency service in a no service area which does not provide a network service are provided. According to exemplary embodiments of the present invention, the mobile terminal in a no service state is able to directly communicate with another neighboring mobile terminal without the intervention of a network. That is, according to exemplary embodiments of the present invention, the mobile terminal in a no service state can form a channel with a neighboring mobile terminal in such a manner that the channel is formed in response to a call connection scenario based on mobile communication between the network and the mobile terminal Accordingly, an optimum environment for the emergency service using a mobile terminal can be implemented. Therefore, exemplary embodiments of the present invention can support emergency service even when the mobile terminal is in a no service state that does not support network service, so that it can rapidly handle the emergency situation of the user. Accordingly, exemplary embodiments of the present invention can enhance the convenience and safety of the mobile terminal user, and can increase the competitiveness of the mobile terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description in conjunction with the accompanying drawings, in which:

FIG. 1 is a block diagram illustrating a configuration of a mobile terminal according to an exemplary embodiment of the present invention;

FIG. 2 is a flow diagram of signals between mobile terminals supporting an emergency service according to an exemplary embodiment of the present invention;

FIG. 3 is a flowchart illustrating a method of providing an emergency service in a transmitting side mobile terminal according to an exemplary embodiment of the present invention; and

FIG. 4 is a flowchart illustrating a method of providing an emergency service in a receiving side mobile terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present invention relates to a control method and a mobile terminal capable of providing an emergency service through a channel setting between mobile terminals without the intervention of a network. More particularly, according to an exemplary embodiment of the present invention, when the mobile terminal is located in an area without service, it can still communicate with another mobile terminal and form a channel. Thus, in an environment (e.g., a no service environment caused by entering a shadow area such as a mountainous area or due to network damage such as a natural disaster) that does not support network service, a user is still able to use an emergency service by connecting with a neighboring mobile terminal, and, accordingly, is rapidly able to handle an emergency situation.

Hereinafter, a configuration of a mobile terminal and a method of controlling an operation according to exemplary embodiments of the present invention are illustrated in more detail with reference to attached drawings.

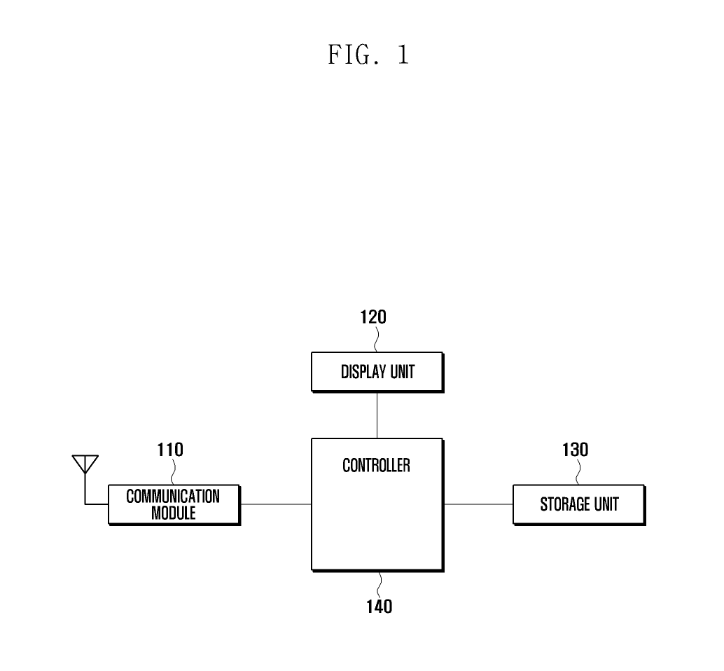

FIG. 1 is a block diagram illustrating a configuration of a mobile terminal according to an exemplary embodiment of the present invention.

Referring to FIG. 1, the mobile terminal includes a communication module 110, a display unit 120, a storage unit 130 and a controller 140. In addition, the mobile terminal can further include an audio processing unit equipped with a microphone and a speaker, a digital broadcasting module for performing the reception and playing of digital broadcasting (e.g., a mobile broadcasting such as the Digital Multimedia Broadcasting (DMB) and the Digital Video Broadcasting (DVB)), a camera module for a photograph/moving-picture function, a bluetooth communication module for performing a blue tooth telecommunication function, a touch pad for a touch-based input, and an input unit for supporting a physical key input. However, for conciseness, the description and illustration of these items are omitted. The communication module 110 denotes a module for supporting a service like a mobile communication based mobile communication service and a Wireless Local Area Network (WLAN) based interne service (e.g., Wi-Fi service). The communication module 110 denotes a module corresponding to a telecommunication function supported by the mobile terminal such as a Radio Frequency (RF) module for performing a mobile communication function and a wireless-LAN module for performing a Wireless Local Area Network (WLAN) based interne communication function. Moreover, in FIG. 1, only one communication module 110 is shown, but the mobile terminal can include the RF module for the mobile communication service and the wireless-LAN module for interne service. Moreover, the mobile terminal can communicate with a network through the RF module to support the mobile communication service and the interne service. The display unit 120 provides an execution screen of applications supported by the mobile terminal. For example, the display unit 120 provides the execution screen for a message function, an E-mail function, an interne function, a multimedia function, a search function, a telecommunication function, an electronic book (e.g., e-book) function, a photograph/moving-picture photographing function, a photograph/moving picture playing function, a Television (TV) playing function (e.g., a DMB or a mobile broadcasting playing function like the DVB), a music playing function (e.g., an MP3 playing function), a widget function, a memo function, a game function, and an emergency function. The display unit 120 normally uses a Liquid Crystal Display (LCD), but can use another display device such as an Organic Light-Emitting Diode (OLED), an Active Matrix OLED (AMOLED), and the like. When displaying the above described execution screen, the display unit 120 can provide the landscape mode or the portrait mode according to a rotation direction (or a placed direction) of the mobile terminal. In an exemplary embodiment of the present invention, the display unit 120 can include an interface supporting a touch based input. For example, the display unit 120 supports the touch based user interaction input through the touch screen and can generate an input signal according to the user interaction input to send to the controller 140. The display unit 120 can display a screen controlled according to the user interaction. The storage unit 130 stores various programs and data which are executed and processed in the mobile terminal, and can include one or more volatile memory devices and non-volatile memory devices.

For example, the storage unit 130 can continuously or temporarily store an operating system of the mobile terminal, a program and data relating to a display control operation of the display unit 120, a program and data relating to an input control operation using the display unit 120, a program and data relating to an emergency service operation in a normal state, and a program and data relating to an emergency service operation in a no service state. More particularly, the storage unit 130 can store an Absolute Radio Frequency Channel Number (ARFCN) of a Broadcast Control Channel (BCCH) carrier which is obtained in the connection with the network of a serving cell. Generally, the BCCH indicates a channel for transmitting information of a common channel control and shell service identification and configuration in the mobile communication system. The BCCH is a downlink dedicated channel with a point to multi point type. The BCCH is used to transmit a service provider identifier, frequency information, a cell identifier, Common Control Channel (CCCH) information, and is allocated to all mobile terminals within a specific cell. That is, the BCCH provides a specific system parameter for the mobile terminal, and the parameter indicates a parameter such as information necessary to recognize or approach a network. Here, in the process where the mobile terminal is turned on to select a cell, firstly, the mobile terminal seeks a Frequency Correction Channel (FCCH) burst and seeks a Synchronization Channel (SCH) burst having the same frequency for synchronization. The mobile terminal receives a signal through the BCCH in several time slots, and can select an appropriate cell according to the received signal. One frequency channel to which a cell is allocated can be used to carry synchronization information and the BCCH, and it is referred as the BCCH carrier. The FCCH indicates a channel which is used to transmit a frequency correction data burst. The FCCH is provided in such a manner that the mobile terminal can refer to the frequency of the system. The CCCH includes a Paging Channel (PCH), an Access Grant Channel (AGCH), and a Random Access Channel (RACH). The CCCH is a point to multipoint downlink dedicated channel used for a call and an access. The network (e.g., base station) calls to communicate with respective mobile terminals existing in its own cell by using the PCH, and the mobile terminal has to scan the PCH during a specific time. The Random Access Channel (RACH) is used by the mobile terminal. The RACH indicates an uplink dedicated channel for transmitting a connection request to the system by the mobile terminal. At this time, the RACH message is a first message which is sent to the network from the mobile terminal when the mobile terminal requests call connection to the network. The controller 140 controls the overall operation of the mobile terminal. As described above, the controller 140 can process the control of an operation in which the mobile terminal operates as a transmitting side mobile terminal or operates as a receiving side mobile terminal. Firstly, when the mobile terminal operates as the transmitting side mobile terminal, the controller 140 can control the operation of the mobile terminal according to the emergency service in a normal state (e.g., a state where network service is supported) and to the emergency service in a state where network service is not supported. For example, when an interaction requesting the execution of emergency service is input, the controller 140 can determine the service state of the mobile terminal. In addition, when the mobile terminal is in a no service state, the controller 140 can operate the mobile terminal with network function (e.g., base station function) and process the transmission and reception of a related signal (or message). That is, when the mobile terminal is in a no service state, the controller 140 generates a channel message (e.g., FCCH message) for forming a channel with another neighboring mobile terminal to support the emergency service and transmits it by a broadcasting method through the communication module 110. At this time, the controller 140 can consecutively transmit the channel message in two frames. According to the reception of the response message (e.g., RACH message) for the channel message from an arbitrary mobile terminal, the controller 140 can control the transmitting and receiving of a voice signal through a channel formed with the other mobile terminal. When the mobile terminal operates as the receiving side mobile terminal, the controller 140 can control the operation according to the general communication service with a network depending on a message type received from the network or an arbitrary mobile terminal, or the operation according to the emergency service for an arbitrary mobile terminal. For example, when a channel message (e.g., FCCH message) requesting the formation of a channel for the emergency service is consecutively received in two frames in a specific mode, the controller 140 can recognize that an emergency request signal is sent from the arbitrary mobile terminal and indicate this to the user. The controller 140 generates a response message (e.g., RACH message) for the channel message according to user input, and sends the response message to the arbitrary mobile terminal through the communication module 110 by a unicasting method. The controller 140 can control the transmitting and receiving of the voice signal through the communication channel formed with the arbitrary mobile terminal according to the sending of a response message. The control operation of the controller 140 is explained in a control method which will be described later. Furthermore, the controller 140 performs various control operations relating to a normal function of the mobile terminal. For example, the controller 140 can control operation and data display when executing an application. Moreover, the controller 140 can receive an input signal corresponding to various input modes supported by the touch based input interface and can control a pertinent function operation. Moreover, in the normal state where the mobile terminal is connected to the network, the controller 140 can control the pertinent function operation in the request of an emergency service by the user.

The mobile terminal according to an exemplary embodiment of the present invention as shown in FIG. 1 can be applied to all types of mobile terminals such as a bar type, a folder type, a slide type, a swing type, a flip type, and the like. Furthermore, the mobile terminal according to exemplary embodiments of the present invention can include any information and telecommunication device, multimedia device, and application device which is capable of transmitting and receiving a voice signal (or message) according to a given communication method. For example, the mobile terminal can include devices such as a tablet Personal Computer (PC), and a Smart phone, as well as a mobile communication terminal operating based on respective communication protocols corresponding to the various communication systems.

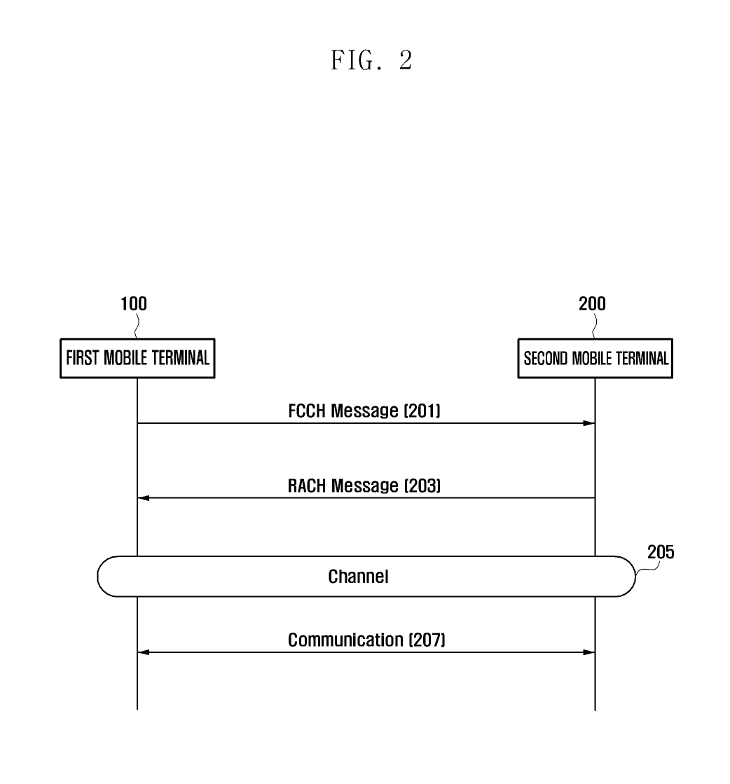

FIG. 2 is a flow diagram of signals between mobile terminals supporting an emergency service according to an exemplary embodiment of the present invention.

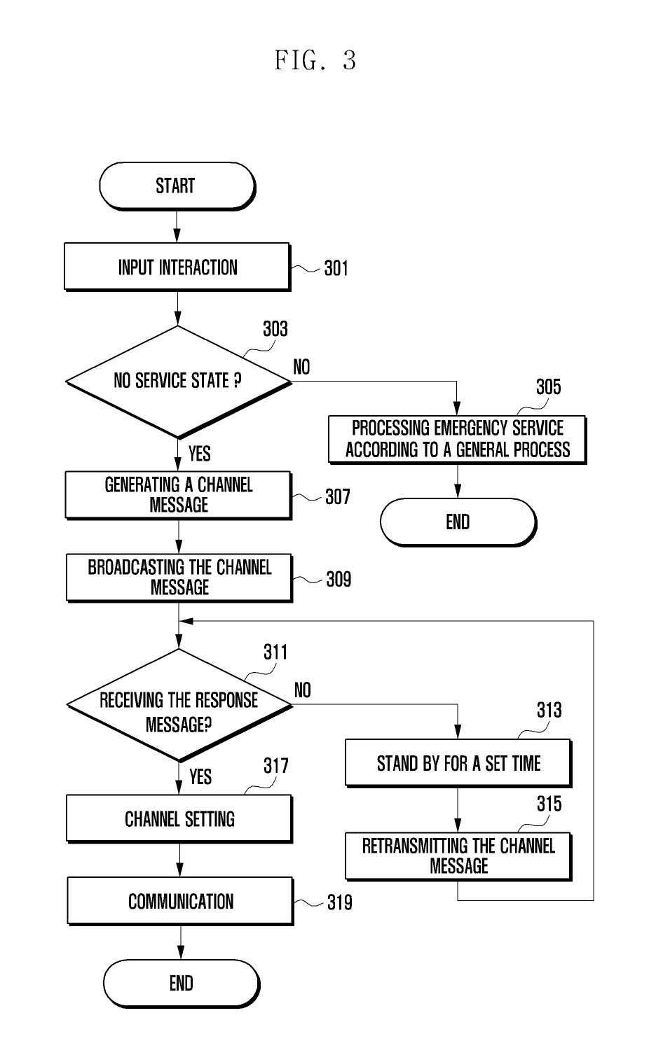

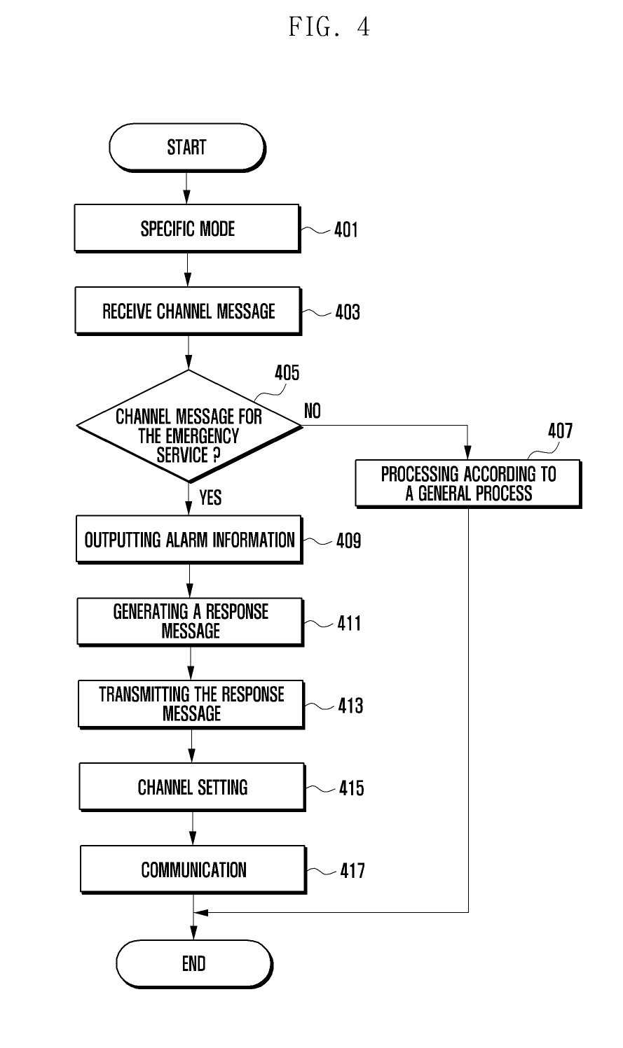

Referring to FIG. 2, a first mobile terminal 100 indicates a transmitting side mobile terminal generating an emergency service according to a user request in an area without network service, and a second mobile terminal 200 indicates a receiving side mobile terminal which exists near the first mobile terminal 100 and directly supports the emergency service through a communication connection with the first mobile terminal 100 without the intervention of a network in the network service area or in a no service area. In FIG. 2, the first mobile terminal 100 is set as a transmitting side mobile terminal and the second mobile terminal 200 is set as a receiving side mobile terminal. However, this is merely for convenience of illustration and not to be considered limiting. Thus, the second mobile terminal 200 can operate as the transmitting side mobile terminal and the first mobile terminal 100 can operate as the receiving side mobile terminal. The first mobile terminal 100 can sense an input of calling for the emergency service when in a no service area. For example, in a dangerous situation, the user can command the execution of an emergency service through a key manipulation for the execution of an emergency service of the first mobile terminal 100. Then, according to exemplary embodiments of the present invention, the first mobile terminal 100 can recognize a no service state in which a network connection is not available when the emergency service is executed. Hereinafter, the signal relation of transmitting and receiving between the first mobile terminal 100 and the second mobile terminal 200 for providing the emergency service of the first mobile terminal 100 in a no service state is illustrated. As shown in FIG. 2, in a no service area, when the first mobile terminal 100 executes the emergency service, the first mobile terminal 100 can broadcast the channel message for setting a channel to a neighboring mobile terminal (e.g., second mobile terminal 200) in step 201. For example, when an emergency service is requested in a no service state, the first mobile terminal 100 can generate channel information for forming a channel with a neighboring mobile terminal and broadcast the generated channel message according to a set period and mode. In an exemplary embodiment of the present invention, the channel message can correspond to the FCCH message. That is, when an emergency service is executed in a no service state, the first mobile terminal 100 can perform the function of the network. Thus, the first mobile terminal 100 can broadcast the FCCH message which includes frequency information to neighboring mobile terminals so that the neighboring mobile terminals may refer to the frequency which enables the first mobile terminal 100 to set a channel. In an exemplary embodiment of the present invention, the FCCH message can be consecutively transmitted in two frames to distinguish from an FCCH message that the general network broadcasts to the mobile terminals within its own cell area. In an exemplary embodiment of the present invention, the frequency that can set a channel can use a frequency according to the ARFCN of the BCCH carrier which is obtained when the first mobile terminal 100 is in connection with the network of the serving cell before the no service state. Then, one or more specific mobile terminal (e.g., second mobile terminal 200) existing near the first mobile terminal 100 can receive the channel message (e.g., FCCH message). At this time, when the channel message is consecutively received in two frames, the second mobile terminal 200 can recognize the channel message as a help signal requesting the emergency service. This can be distinguished by a promised protocol between mobile terminals according to an exemplary embodiment of the present invention. The second mobile terminal 200 can transmit a response message (e.g., RACH message) to the first mobile terminal 100 by unicasting in response to the channel message of the first mobile terminal 100 in step 203. For example, the second mobile terminal 200 informs the user of the reception of the channel message, and can generate a response message for the channel message according to user input. In an exemplary embodiment of the present invention, the response message may correspond to the RACH message in which the second mobile terminal 200 requests the first mobile terminal 100 for connection. That is, the RACH message indicates a first message transmitted from the mobile terminal to a network when the mobile terminal requests the network for call connection, and, in an exemplary embodiment of the present invention, it can be used as a message that the second mobile terminal 200 requests the first mobile terminal 100 for call connection. That is, the response message can be a message with which the second mobile terminal 200 responds to channel setting with reference to frequency information that is included in the channel message. A channel for communication can be formed between the first mobile terminal 100 and the second mobile terminal 200 when the channel message (e.g., FCCH message) and the response message (e.g., RACH message) are transmitted and received between the first mobile terminal 100 and the second mobile terminal 200 in step 205. At this time, as described above, a frequency according to ARFCN of a previous serving cell of the first mobile terminal 100 promised by the transmission and reception of the channel message and the response message can be used as the frequency used in the formed channel. The first mobile terminal 100 and the second mobile terminal 200 can perform the communication through the formed channel in step 207. That is, the first mobile terminal 100 and the second mobile terminal 200 can mutually communicate a voice signal input from each user. For example, when a channel is formed with the second mobile terminal 200 and a voice signal is input from the user, the first mobile terminal 100 loads the voice signal on the frequency allocated by the channel and transmits it to the second mobile terminal 200, or can receive the voice signal transmitted from the second mobile terminal 200 and output it. Moreover, when the channel is formed with the first mobile terminal 100 and the voice signal is input from the user, the second mobile terminal 200 loads the voice signal on the frequency allocated by the channel and transmits it to the first mobile terminal 100, or can receive the voice signal transmitted from the first mobile terminal 100 and output it. In FIG. 2, it is illustrated that a call service is provided between mobile terminals through a voice signal as an alternative of the emergency service. However, when the voice input by the user of the first mobile terminal 100 is impossible, a preset recorded voice signal may be transmitted to the second mobile terminal 200 through the formed channel, or a channel message which is previously set or input by the user can be transmitted to the second mobile terminal 200 through the formed channel. Hereinafter, a control operation is illustrated with reference to FIGS. 3 and 4 in terms of the first mobile terminal 100 and the second mobile terminal 200 illustrated in FIG. 2.

FIG. 3 is a flowchart illustrating an operation method of emergency service according to an exemplary embodiment of the present invention. More particularly, FIG. 3 illustrates an operation method of emergency service in terms of a first mobile terminal 100 according to FIG. 2.

Referring to FIG. 3, the controller 140 can sense an interaction input of calling the emergency service in step 301. For example, the user of the mobile terminal can command the execution of the emergency service through the operation of a menu or a function key equipped in the mobile terminal for the execution of the emergency service in an emergency situation like distress. The controller 140 can receive a corresponding input signal when the user inputs an interaction for the execution of the emergency service. When the interaction for the emergency service is input, the controller 140 determines whether the mobile terminal is in an area without service or in a normal service state in step 303. For example, the controller 140 can determine whether the mobile terminal is connected to a specific network to support network service or whether the mobile terminal is not connected to any network and is in a no service state in which network service is not supported. When it is determined in step 303 that the mobile terminal is in a service state (NO of step 303), i.e., when it is the normal state which supports the network service, the controller 140 can use an emergency service function according to a general process in step 305. For example, the controller 140 can generate a channel message according to the emergency service and transmit it through the connected network, or can send an emergency call according to the emergency service through the connected network. On the other hand, when it is determined in step 303 that the mobile terminal is in a no service state which does not support network service (YES of step 303), the controller 140 can generate a channel message for the emergency service in the no service state in step 307. For example, when it is determined that the mobile terminal is in a no service state, the controller 140 can generate a channel message for setting a channel with neighboring mobile terminals. In an exemplary embodiment of the present invention, as described above, the channel message may correspond to the FCCH message, and may include frequency information so that neighboring mobile terminals may refer to the frequency that can be used to set a channel. The controller 140 can broadcast the generated channel message in step 309.

For example, the controller 140 can broadcast the generated channel message through the transmission channel. In an exemplary embodiment of the present invention, the channel message can be transmitted for two frames to discern that it is a channel message for the request of a help signal. That is, the channel message can be consecutively transmitted in two frames to distinguish it from the channel message broadcast from a general network. The controller 140 determines the reception of the response message (e.g., RACH message) for the channel message after the transmission of the channel message (e.g., FCCH message) in step 311. For example, the controller 140 can determine whether a response message (e.g., RACH message) corresponding to the channel message (e.g., FCCH message) is received from a specific mobile terminal through the reception channel during standby after the transmission of the channel message (e.g., FCCH message). When it is determined in step 311 that the response message (e.g., RACH message) for the channel message (e.g., FCCH message) is not received (NO of step 311), the controller 140 can stand by for a set time in step 313. After the set time, the controller 140 retransmits the channel message (e.g., FCCH message) in step 315, and returns to step 311 and can again stand by for the reception of response message (e.g., RACH message). On the other hand, when it is determined in step 311 that the response message (e.g., RACH message) for the channel message (e.g., FCCH message) is received (YES of step 311), the controller 140 can form a channel with the mobile terminal that sent the response message in step 317. The controller 140 can control the function operation according to the execution of communication with other mobile terminal through the formed channel in step 319. For example, the user can provide a voice input through a microphone similar to performing a normal call function. Also, the controller 140 can receive the voice signal sent from the microphone and can transmit it to the other mobile terminal through the communication module 110. Moreover, the controller 140 can receive the voice signal transmitted from the other mobile terminal through the communication module 110 and output it through a speaker.

FIG. 4 is a flowchart illustrating an operation method of emergency service in a mobile terminal according to an exemplary embodiment of the present invention. More particularly, FIG. 4 illustrates an operation method of emergency service in terms of a second mobile terminal 200 according to FIG. 2.

Referring to FIG. 4, during the operation of a specific mode in step 401, the controller 140 can receive a channel message in step 403. For example, when the mobile terminal is an idle state or a limited state, the controller 140 can receive the channel message while checking a paging channel. Alternatively, when the mobile terminal is in a no service state, the controller 140 can receive a channel message while performing a frequency scan. The controller 140 determines whether the received channel message corresponds to a channel message (e.g., FCCH message) for the emergency service in step 405. For example, when the channel message is received during the operation of the specific mode, the controller 140 can determine that a corresponding channel message is a general channel message from a network or a channel message including a request for help which is previously agreed according to an exemplary embodiment of the present invention. At this time, when the channel message is consecutively received in two frames, the controller 140 can determine that a corresponding channel is the channel message (FCCH message) which corresponds to a request for help according to a protocol between mobile terminals according to an exemplary embodiment of the present invention. When it is determined in step 405 that the received channel message is not a channel message according to the emergency service (NO of step 405), the controller 140 can process the operation corresponding to the channel message according to a general process in step 407.

For example, when the channel message is a message sent from the network, the controller 140 can generate a response message corresponding to the channel message and transmit it to the network. That is, when the channel message corresponds to a signal communicating with the network for a general mobile communication service, the controller 140 can perform a corresponding signal processing. When it is determined in step 405 that the channel message is a channel message (e.g., FCCH message) according to the emergency service (YES of 405), the controller 140 alarms the user that the channel message (e.g., FCCH message) regarding an emergency service is received in step 409. For example, the controller 140 can alarm the user in such a manner that alarm information is output when the call is received from the network according to a general process. The alarm information can be output through at least one of displaying user information (e.g., the name, the telephone number of calling party, or the like) through the display unit 120, outputting an oscillation, outputting a sound, and the like. The controller 140 can additionally display emergency information informing that the call connection request and the alarm information are a call connection request corresponding to the emergency service so as to intuitively inform that it is the call connection request according to the channel message corresponding to a help signal according to exemplary embodiments of the present invention. The emergency information can be displayed together with the user information through the display unit 120. The controller 140 generates a response message (e.g., RACH message) for the channel message according to user selection in step 411, and transmits the generated response message to the other mobile terminal which transmitted the channel message in step 413. For example, when an input (e.g., call connection button input) responding to a call connection request according to the channel message is received from the user after the alarm according to reception of the channel message is output, the controller 140 generates a response message and transmits it to the other mobile terminal which transmitted the channel message by a unicasting method. The controller 140 can form a channel with the other mobile terminal after the transmission of the response message (e.g., RACH message) in step 415. The controller 140 can control the function operation according to the execution of communication with the other mobile terminal through the formed channel in step 417. For example, the user can provide a voice input through a microphone similar to performing a normal call function. And, the controller 140 can receive the voice signal sent from the microphone and transmit it to the other mobile terminal through the communication module 110. Moreover, the controller 140 can receive the voice signal sent from the other mobile terminal through the communication module 110 and output it through a speaker. The operating method for emergency service according to exemplary embodiments of the present invention can be implemented in the form of a program command which can be executed through various computer systems and can be recorded in a recording medium which is readable by a computer. At this time, the recording medium which is readable by a computer can include a program command, a data file, and a data structure independently or in combination. The program command recorded in the recording medium is specially designed and configured for exemplary embodiments of the present invention or is known to a person skilled in the computer software and is usable. The recording medium which is readable by computer includes a magnetic media like a hard disk, a floppy disk and a magnetic tape, an optical media like a Compact Disc Read Only Memory (CD-ROM), and a Digital Versatile Disc (DVD), a magneto-optical media like a floptical disk, and a hardware device which is specially configured to store and perform a program command such as Read Only Memory (ROM), Random Access Memory (RAM), and a flash memory. Moreover, the program command includes not only a machine code made by compiler but also a high level language code which can be executed by computer by using interpreter. The above-described hardware device can be configured to operate as one or more software modules so as to perform the operation of the present invention, and vice versa.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of providing an emergency service, the method comprising:
broadcasting a channel message by a first mobile terminal in a no service state in response to a request for an emergency service;
transmitting a corresponding response message to the first mobile terminal when a second mobile terminal receives the channel message from the first mobile terminal;
forming a channel between the first mobile terminal and the second mobile terminal; and
performing a communication according to the emergency service between the first mobile terminal and the second mobile terminal by using the formed channel.

2. The method of claim 1, wherein the broadcasting of the channel message comprises consecutively broadcasting the channel message in two frames.

3. The method of claim 2, wherein the performing of the communication comprises sending and receiving a voice signal by the first mobile terminal and the second mobile terminal through the channel directly connected without an intervention of a network.

4. The method of claim 2, wherein the channel message comprises a Frequency Correction Channel (FCCH) message that the first mobile terminal broadcasts by including frequency information for channel setting, and the response message comprises a Random Access Channel (RACH) message that the second mobile terminal responds to the channel setting with reference to the frequency information.

5. The method of claim 4, wherein the frequency information comprises a frequency according to an Absolute Radio Frequency Channel Number (ARFCN) obtained in a previous serving cell of the first mobile terminal.

6. The method of claim 1, further comprising:
receiving an input of interaction for execution of the emergency service by the first mobile terminal;
determining a service state when the interaction is input;
generating the channel message including frequency information which can refer to a channel settable frequency in case of a no service state which does not support network service; and
consecutively broadcasting the channel message in two frames.

7. The method of claim 6, further comprising:
awaiting reception of the response message for a set time after the broadcasting of the channel message; and
retransmitting the channel message when the response message is not received during the set time.

8. The method of claim 1, further comprising:
receiving the channel message during an execution of a specific mode by the second mobile terminal;
determining whether the channel message is a channel message according to the emergency service;
outputting emergency information to a user when the channel message is the channel message according to the emergency service; and
generating a response message corresponding to the channel message according to user selection and unicasting it to the first mobile terminal.

9. The method of claim 8, wherein the determining of whether the channel message is a channel message according to the emergency service comprises determining that the channel message is a channel message according to the emergency service when the channel message is consecutively received in two frames.

10. The method of claim 8, wherein the second mobile terminal receives the channel message while checking a paging channel in case of an idle state or a limited state, or receives the channel message while scanning a frequency in case of a no service state.

11. A system for providing an emergency service, the system comprising:
a first mobile terminal for generating and broadcasting a channel message for an emergency service in a no service state, and for performing communication according to the emergency service after setting a channel with a corresponding mobile terminal when receiving a response message corresponding to the channel message; and
a second mobile terminal for, when receiving the channel message that the first mobile terminal broadcasts, unicasting a corresponding response message to the first mobile terminal, and for performing communication according to the emergency service through the channel set with the first mobile terminal.

12. The system of claim 11, wherein the first mobile terminal and the second mobile terminal send and receive a voice signal through a channel which is directly set without an intervention of network.

13. The system of claim 12, wherein the first mobile terminal consecutively broadcasts the channel message in two frames when the emergency service is performed in a no service state.

14. The system of claim 13, wherein the second mobile terminal determines the channel message as a message for the emergency service when the channel message is consecutively received in two frames.

15. The system of claim 12, wherein the channel message comprises a Frequency Correction Channel (FCCH) message including the frequency information for channel setting which the first mobile terminal broadcasts, and the response message comprises a Random Access Channel (RACH) message with which the second mobile terminal responds to the channel setting by referencing the frequency information.

16. The system of claim 15, wherein the frequency information comprises a frequency according to an Absolute Radio Frequency Channel Number (ARFCN) obtained in a previous serving cell of the first mobile terminal.

17. A method of providing an emergency service by a mobile terminal, the method comprising:
broadcasting a channel message in a no service state in response to a request for an emergency service;
receiving a corresponding response message to the request for emergency service;
forming a direct channel with another mobile terminal; and
performing a communication according to the emergency service using the direct channel.

18. The method of claim 17, wherein the broadcasting of the channel message comprises consecutively broadcasting the channel message in two frames.

19. The method of claim 18, wherein the channel message comprises a Frequency Correction Channel (FCCH) message that includes frequency information for channel setting.

20. The method of claim 19, wherein the frequency information comprises a frequency according to an Absolute Radio Frequency Channel Number (ARFCN) obtained in a previous serving cell of the first mobile terminal.
